(19) United States
(12) Patent Application Publication
(10) Pub. No.: US 2026/0246326 A1
(43) Pub. Date: Aug. 20, 2026

(54) ROTATIONAL COMPONENT FOR A ROTARY SYSTEM

(71) Applicant: Schaeffler Technologies AG & Co. KG, Herzogenaurach (DE)

(72) Inventor: Long Souers, North Canton, OH (US)

(73) Assignee: Schaeffler Technologies AG & Co. KG, Herzogenaurach (DE)

(21) Appl. No.: 19/055,215

(22) Filed: Feb. 17, 2025

(51) Int. Cl. H02K 1/28; H02K 15/14; H02K 15/40; H02K 24/00

(52) U.S. Cl. CPC H02K 1/28; H02K 15/14; H02K 15/40; H02K 24/00

(57) ABSTRACT

A rotational component for a rotary system includes a sleeve that defines an aperture extending therethrough, through which an axis about which the rotational component is configured to rotate in the rotary system extends. The sleeve includes a shelf portion configured to accommodate a resolver of the rotary system that rests upon the shelf portion. A collar portion extends axially from the shelf portion to a distal end of the collar portion, the collar portion having an interior surface that partially defines the aperture and an exterior surface opposite the interior surface that defines a recess that initiates a first axial distance from the shelf portion. The resolver is configured to extend a second axial distance from the shelf portion, and the first axial distance is greater than the second axial distance.

### FIELD OF THE DISCLOSURE

The present disclosure generally relates to a rotational component for a rotary system. More specifically, the present disclosure relates to a rotational component that includes a resolver and a method of assembling the resolver to the rotational component.

### BACKGROUND OF THE DISCLOSURE

Rotary systems, such as torque converters and electric motor assemblies, often include resolvers that are coupled to a rotational component of the rotary system.

### SUMMARY OF THE DISCLOSURE

According to a first aspect of the present disclosure, a rotational component for a rotary system includes a sleeve that defines an aperture extending therethrough, through which an axis about which the rotational component is configured to rotate in the rotary system extends. The sleeve includes a shelf portion configured to accommodate a resolver of the rotary system that rests upon the shelf portion. A collar portion extends axially from the shelf portion to a distal end of the collar portion, the collar portion having an interior surface that partially defines the aperture and an exterior surface opposite the interior surface that defines a recess that initiates a first axial distance from the shelf portion. The resolver is configured to extend a second axial distance from the shelf portion, and the first axial distance is greater than the second axial distance.

Embodiments of the first aspect of the disclosure can include any one or a combination of the following features:
the exterior surface of the collar portion of the sleeve includes a defining face that defines the recess, and wherein the defining face includes a first portion disposed proximate to the initiation of the recess at the first axial distance from shelf portion that follows a curve within a plane defined by an axial direction and a radial direction and a second portion that angles radially outboard as the second portion extends axially toward the shelf portion;
the second portion extends substantially linearly within the plane defined by the axial and radial directions;
the second portion is larger than the first portion;
the second portion extends an axial distance that is greater than half of the second axial distance that the resolver is configured to extend from the shelf portion;
the recess partially defines a neck and a head of the collar portion; and
the neck is configured to be deformed to allow the head to contact the resolver in a process of staking.

According to a second aspect of the present disclosure, a rotational component for a rotary systema sleeve that defines an aperture extending therethrough, through which an axis about which the rotational component is configured to rotate in the rotary system extends. The sleeve includes a shelf portion configured to accommodate a resolver of the rotary system that rests upon the shelf portion. A collar portion extends axially from the shelf portion to a distal end of the collar portion, the collar portion having an interior surface that partially defines the aperture and an exterior surface opposite the interior surface. The exterior surface includes a defining face that defines a recess, wherein the defining face includes a first portion that initiates at a first axial distance from the shelf portion and extends to a second portion that angles radially outboard as the second portion extends axially toward the shelf portion therefrom.

Embodiments of the second aspect of the disclosure can include any one or a combination of the following features:
the first axial distance is greater than a second axial distance that the resolver is configured to extend from the shelf portion;
the first portion of the defining face follows a curve within a plane defined by an axial direction and a radial direction;
the second portion extends substantially linearly within the plane;
the second portion is larger than the first portion;
the rotational component is a portion of a rotor hub; and
the rotational component is a rotor flange of the rotor hub.

According to a third aspect of the present disclosure, a method of assembling a resolver to a rotational component that is configured to rotate about an axis is disclosed. The method includes the steps of: disposing a resolver about a collar portion of a sleeve of the rotational component, such that the resolver contacts a shelf portion of the sleeve that extends radially outboard relative to the collar portion, wherein an exterior surface of the collar portion includes a defining face that defines a recess that initiates at a first axial distance from the shelf portion and extends toward the shelf portion therefrom, and wherein the resolver is disposed such that the resolver extends a second axial distance from the shelf portion that is less than the first axial distance; and deforming the sleeve, such that a portion of the defining face of the collar portion wraps about a corner of the resolver, sandwiching the resolver against the shelf portion to limit axial deformation of the resolver.

Embodiments of the third aspect of the disclosure can include any one or a combination of the following features and/or steps:
the step of deforming the sleeve comprises staking a portion of the sleeve;
in the step of deforming the sleeve, a plurality of portions of the sleeve that are circumferentially offset from each other are deformed via staking;
prior to the step of deforming the sleeve, the defining face includes a first portion that initiates at the first axial distance from the shelf portion and extends to a second portion that angles radially outboard as the second portion extends axially toward the shelf portion therefrom;
prior to the step of deforming the sleeve, the first portion of the defining face follows a curve within a plane defined by an axial direction and a radial direction; and
prior to the step of deforming the sleeve, the second portion extends substantially linearly within the plane.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a cross-sectional view of a segment of a rotor hub of an electric motor disposed within a manufacturing apparatus, according to one embodiment;

FIG. 2 is an enlarged view of a portion of FIG. 1, illustrating a rotational component having a sleeve that includes a collar portion that defines a recess and a shelf portion, and a resolver disposed on the shelf portion, according to one embodiment;

FIG. 3 is a cross-sectional view of a portion of the collar portion of the sleeve of the rotational component, illustrating a recess defined by a defining face of an exterior surface of the collar portion, according to one embodiment;

FIG. 4 is a cross-sectional view, illustrating a portion of the sleeve of the rotational component deformed about a resolver, such that a defining face of the exterior surface of the collar portion of the sleeve that defines the recess wraps about a corner of the resolver, according to one embodiment; and

FIG. 5 is a flow diagram illustrating steps of a method of assembling a resolver to a rotational component of a rotary system, according to one embodiment.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along an axis about which a rotational is configured to rotate in operation of the rotary system described herein. Further, the term “radial” and derivatives thereof, such as “radially,” shall be understood in relation to the axis of the aforementioned rotational component. For example, “radially outboard” refers to further away from the axis, while “radially inboard” refers to nearer to the axis. The term “circumferential” and derivatives thereof, such as “circumferentially,” shall be understood in relation to the axis of the aforementioned rotational component.

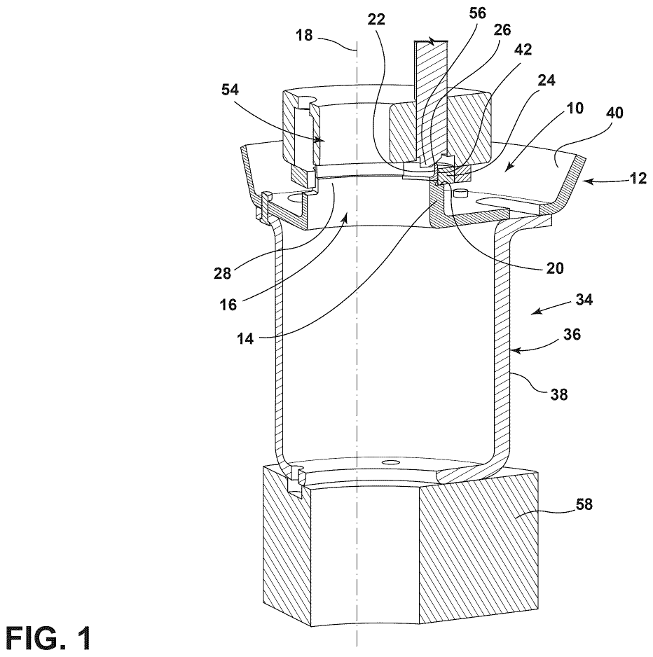

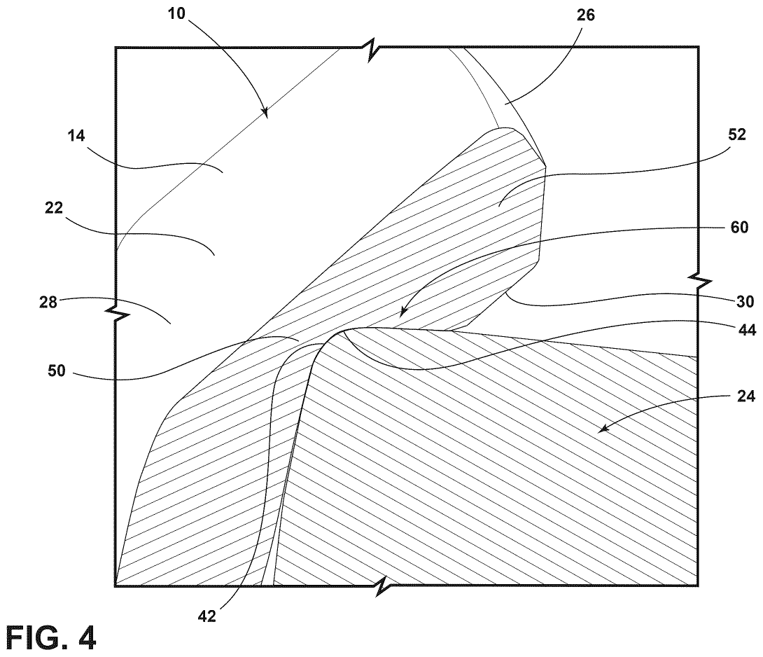

Referring now to FIGS. 1-5, a rotational component 10 for a rotary system 12 includes a sleeve 14 that defines an aperture 16 extending therethrough. An axis 18 about which the rotational component 10 is configured to rotate in the rotary system 12 extends through the aperture 18 defined by the sleeve 14. The sleeve 14 includes a shelf portion 20 and a collar portion 22. The shelf portion 20 is configured to accommodate a resolver 24 of the rotary system 12 that rests upon the shelf portion 20. The collar portion 22 extends axially from the shelf portion 20 to a distal end 26 of the collar portion 22. The collar portion 22 includes an interior surface 28 that partially defines the aperture 16, and an exterior surface 30 opposite the interior surface 28 that defines a recess 32. The recess 32 initiates a first axial distance from the shelf portion 20. The resolver 24 is configured to extend a second axial distance from the shelf portion 20. The first distance is greater than the second distance.

Referring now to FIGS. 1-4, in various implementations, the rotary system 12 may be an electric motor assembly 34. For example, as illustrated in FIG. 1, a rotor hub 36 of the electric motor assembly 34 is illustrated. The rotor hub 36 includes a rotor carrier 38 and a rotor flange 40 that is coupled to an axial end of the rotor carrier 38. As illustrated, the rotational component 10 is the rotor flange 40 in the embodiment illustrated in FIG. 1. A variety of types of rotary systems 12 and rotational components 10 are contemplated. For example, in some implementations, the rotary system 12 may be a torque converter, and the rotational component 10 can be an impeller of the torque converter.

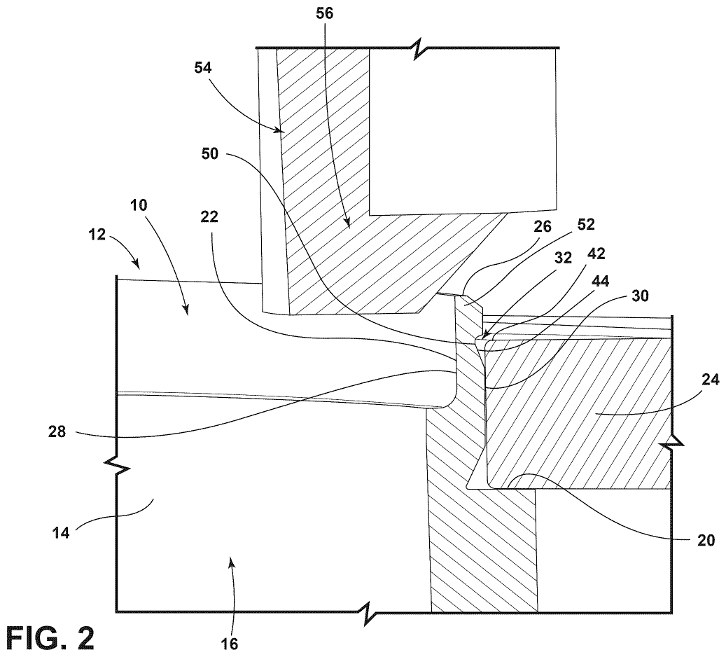

Referring still to FIGS. 1-4, in various implementations, the rotational component 10 includes the sleeve 14 that defines the aperture 16 extending through the rotational component 10. As illustrated in FIG. 1, the axis 18 about which the rotational component 10 is configured to rotate in the rotary system 12 extends through the aperture 16 defined by the sleeve 14 of the rotational component 10. The sleeve 14 includes the shelf portion 20. As illustrated in FIG. 2, the shelf portion 20 extends radially-outboard relative to an adjacent portion of the sleeve 14, creating a shelf-like surface. As illustrated in FIG. 2, the resolver 24 is configured to rest upon the shelf portion 20 during a segment of the process of assembling the resolver 24 to the rotational component 10, and the resolver 24 is configured to be sandwiched between the shelf portion 20 and another portion of the sleeve 14, as described further herein.

The sleeve 14 of the rotational component further 10 includes the collar portion 22. The collar portion 22 extends axially from the shelf portion 20 to the distal end 26 of the collar portion 22, as illustrated in FIG. 2. The collar portion 22 includes the interior surface 28 and the exterior surface 30 that is opposite the interior surface 28. The interior surface 28 of the collar portion 22 defines the aperture 26 through which the axis 18 extends, and the exterior surface 30 defines the recess 32. The recess 32 defined by the exterior surface 30 of the collar portion 22 may be generally aligned with a corner 42 of the resolver 24, such that during the process of assembling the resolver 24 to the rotational component 10 via a manufacturing apparatus 54, the collar portion 22 of the sleeve 14 deforms as desired to secure the resolver 24 to the rotational component 10, as described further herein.

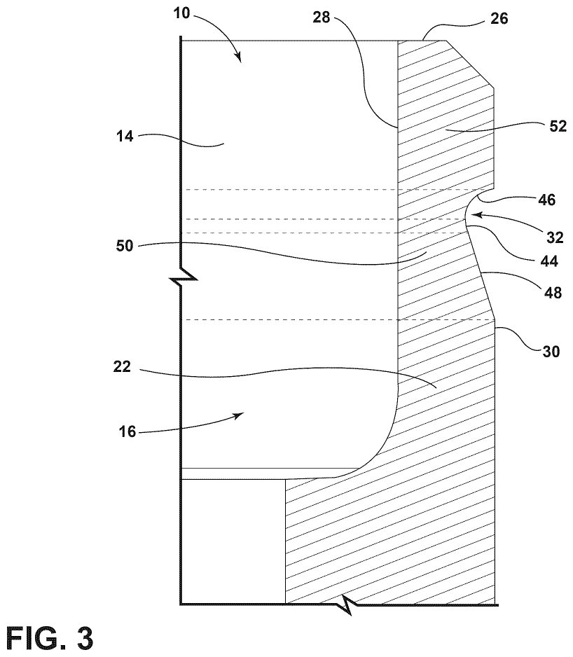

Referring now to FIGS. 2-4, in various implementations, the exterior surface 30 of the collar portion 22 of the sleeve 14 includes a defining face 44, and the defining face 44 defines the recess 32. In some implementations, the defining face 44 includes a first portion 26 disposed proximate to the initiation of the recess 32 at a first axial distance from the shelf portion 20, and a second portion 48 that angles radially outboard as the second portion 48 extends axially toward the shelf portion 20 from the first portion 46. In some embodiments, the first portion 46 of the defining face 44 may follow a curve within a plane that is defined by an axial direction and a radial direction. Further, in some implementations, the second portion 48 may extend substantially linearly within the plane defined by the axial and radial directions. For example, in the embodiment illustrated in FIG. 3, the defining face 44 includes the first portion 46 that is disposed proximate to the initiation of the recess 32 and that follows a curve within a plane defined by an axial direction and a radial direction, and the defining face 44 includes the second portion 48 that extends substantially linear at an angle within the plane defined by the axial direction and the radial direction as the second portion 48 extends axially toward the shelf portion 20 from the first portion 46 of the defining face 44. In various implementations, the second portion 48 may be larger than the first portion 46, as illustrated in FIG. 3. Further, as illustrated in FIG. 3, the radially-inboard-most portion of the defining face 44 may be a portion of the first portion 46 of the defining face 44. In some implementations, the second portion 48 of the defining face 44 may extend as a tangent of the terminus of the curve that forms the first portion 46 of the defining face 44.

Referring still to FIGS. 2-4, in various implementations, the collar portion 22 of the sleeve 14 of the rotational component 10 includes a neck 50 and a head 52. As illustrated in FIG. 3, in some implementations, the recess 32 partially defines the neck 50 and the head 52 of the collar portion 22. As illustrated, the head 52 is nearer than the collar portion 22 to the distal end 26 of the collar portion 22. In various implementations, the neck 50 is configured to be deformed during the process of assembling the resolver 24 to the rotational component 10 to allow the head 52 to contact the resolver 24 in that process. In various implementations, the neck 50 is configured to be deformed to allow the head 52 to contact the resolver 24 in the process of staking the collar portion 22 to the resolver 24.

Referring still to FIGS. 2-4, in various implementations, the recess 32 initiates a first axial distance from the shelf portion 20 and extends axially toward the shelf portion 20 therefrom, and the resolver 24 is disposed upon the shelf portion 20 and extends a second axial distance therefrom, generally toward the distal end 26 of the collar portion 22, wherein the first axial distance is greater than the second axial distance. As such, as illustrated in FIGS. 2 and 3, the corner 42 of the resolver 24 that is axially distal from the shelf portion 20 upon which the resolver 24 is disposed is axially aligned with a portion of the recess 32 defined by the collar portion 22, and the recess 32 extends axially beyond the corner 42 of the resolver 24 in an axial direction that is away from the shelf portion 20. As illustrated in FIGS. 2 and 3, the defining face 44 includes the first portion 46 that initiates at the first axial distance from the shelf portion 20 and extends to the second portion 48 therefrom, and the resolver 24 is configured to extend from the shelf portion 20 the second axial distance, wherein the first axial distance is greater than the second axial distance.

In various implementations, the resolver 24 is generally ring-shaped, defining an aperture that extends therethrough. In various embodiments, the resolver 24 is formed of a plurality of laminations that are stacked upon one another to form the generally ring-shaped structure. The resolver 24 may be configured to measure the position, speed, and/or direction of rotation of the rotational component 10 of the rotary system 12 in various embodiments. In various implementations, the resolver 24 is a resolver rotor.

Referring now to FIGS. 1-4, in various implementations, in the process of manufacturing the rotary system 12, such that the resolver 24 is secured to the rotational component 10 of the rotary system 12, the resolver 24 is disposed about the sleeve 14 of the rotational component 10 (i.e., the collar portion 22 extends through the aperture defined by the ring-shaped resolver 24). The collar portion 22 of the rotational component 10 is then deformed to form a retention feature 60 that aids in securing the resolver 24 to the rotational component 10. In an exemplary implementation, the manufacturing apparatus 54 includes a punch 56 that is configured to deform the collar portion 22 of the rotational component 10 to form a plurality of retention features 60 through the process of staking the rotational component 10 and the resolver 24. As illustrated in FIG. 1, a support structure 58 of the manufacturing apparatus 54 is positioned to support the portion of the rotary system 12 (here, the rotor carrier 38 of the rotor hub 36) opposite the portion of the manufacturing apparatus 54 that performs the staking of the rotational component 10 with the resolver 24. In various implementations, the manufacturing apparatus 54 may deform a plurality of portions of the collar portion 22 of the sleeve 14 of the rotational component 10 to form a plurality of retention features 60 that are circumferentially offset relative to each other. It is contemplated that a variety of types of manufacturing apparatuses 54 may be utilized in deforming the collar portion 22 of the sleeve 14 of the rotational component 10 to secure the resolver 24 to the rotational component 10. Further, the manufacturing apparatus 54 may perform a variety of types of deformation of the collar portion 22 alternatively or in addition to staking, in various embodiments.

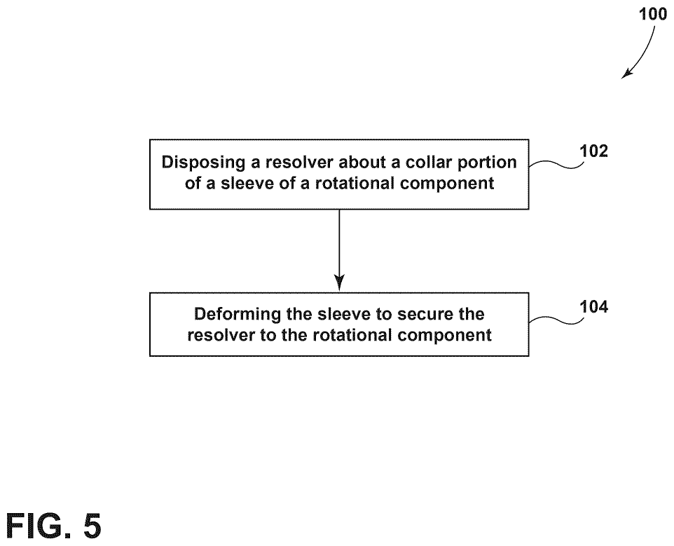

Referring now to FIG. 5, a method 100 of assembling a resolver 24 to a rotational component 10 configured to rotate about an axis 18 is illustrated. The method 100 includes the step 102 of disposing the resolver 24 about the collar portion 22 of the sleeve 14 of the rotational component 10. In various implementations, at step 102, the resolver 24 is disposed about the collar portion 22 such that the resolver 24 contacts the shelf portion 20 of the sleeve 14 that extends radially outboard relative to the collar portion 22. In some implementations, the resolver 24 is disposed about the collar portion 22, such that the recess 32 defined by the defining face 44 of the exterior surface 30 of the collar portion 22, which initiates at a first axial distance from the shelf portion 20 and extends toward the shelf portion 20 therefrom, initiates at a point that is axially further than the corner 42 of the resolver 24 that is axially distal from the shelf portion 20 of the sleeve 14. In other words, in some implementations, the resolver 24 is disposed such that the recess 32 initiates at the first axial distance from the shelf portion 20 that extends toward the shelf portion 20 therefrom, and the resolver 24 extends a second axial distance from the shelf portion 20 that is less than the first axial distance.

Referring still to FIG. 5, the method 100 can include a step 104 of deforming the sleeve 14 to secure the resolver 24 to the rotational component 10. In various implementations, at step 104, the sleeve 14 is deformed such that a portion of the defining face 44 of the collar portion 22 wraps about the corner 42 of the resolver 24. As such, the resolver 24 is sandwiched against the shelf portion 20 by the retention feature 60 to limit axial deformation of the resolver 24. In various embodiments, the step 104 of deforming the sleeve 14 includes staking a portion of the sleeve 14. In some embodiments, in the step 104 of deforming the sleeve 14, a plurality of portions of the sleeve 14 that are circumferentially offset from each other are deformed via staking to form a plurality of retention features 60.

Referring still to FIG. 5, in some implementations, prior to the step 104 of deforming the sleeve 14, the defining face 44 includes the first portion 46 that initiates at the first axial distance from the shelf portion 20 and extends to the second portion 48 that angles radially outboard as the second portion 48 extends axially toward the shelf portion 20 therefrom. In some implementations of the method 100, prior to the step 104 of deforming the sleeve 14, the first portion 46 of the defining face 44 follows a curve within a plane defined by an axial direction and a radial direction. In various implementations, prior to the step 104 of deforming the sleeve 14, the second portion 48 of the defining face 44 extends substantially linearly within the plane.

The rotational component 10 and the method 100 of assembling the resolver 24 to the rotational component 10 of the present disclosure may provide a variety of advantages. First, the collar portion 22 of the sleeve 14 of the rotational component 10 defining the recess 32, which is axially aligned with the corner 42 of the resolver 24 disposed about the sleeve 14, may decrease the amount of radial deformation that occurs to the collar portion 22 during a process of staking the collar portion 22 to the resolver 24 to retain the resolver 24 on the rotational component 10 relative to a system that includes a collar portion that does not define the recess. Second, sandwiching the resolver 24 between the shelf portion 20 of the sleeve 14 and the retention feature 60 created via deformation of the collar portion 22 of the sleeve 14 aids in limiting axial deformation of the resolver 24 in operation of the rotary system 12 that utilizes the rotational component 10 and the resolver 24.

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

rotational
10 component
12 rotary system
14 sleeve
16 aperture of sleeve
18 axis
20 shelf portion
22 collar portion
24 resolver
26 distal end
28 interior surface
30 exterior surface
32 recess
electric motor
34 assembly
36 rotor hub
38 rotor carrier
40 rotor flange
42 corner
44 defining face
46 first portion
48 second portion
50 neck
52 head
manufacturing
54 apparatus
56 punch
58 support structure
60 retention feature
1000 method
102 step
104 step

What is claimed is:

1. A rotational component for a rotary system, comprising:
a sleeve that defines an aperture extending therethrough, through which an axis about which the rotational component is configured to rotate in the rotary system extends, the sleeve comprising:
a shelf portion configured to accommodate a resolver of the rotary system that rests upon the shelf portion; and
a collar portion that extends axially from the shelf portion to a distal end of the collar portion, the collar portion having an interior surface that partially defines the aperture and an exterior surface opposite the interior surface that defines a recess that initiates a first axial distance from the shelf portion, wherein the resolver is configured to extend a second axial distance from the shelf portion, and the first axial distance is greater than the second axial distance.

2. The rotational component of claim 1, wherein the exterior surface of the collar portion of the sleeve includes a defining face that defines the recess, and wherein the defining face includes a first portion disposed proximate to the initiation of the recess at the first axial distance from shelf portion that follows a curve within a plane defined by an axial direction and a radial direction and a second portion that angles radially outboard as the second portion extends axially toward the shelf portion.

3. The rotational component of claim 2, wherein the second portion extends substantially linearly within the plane defined by the axial and radial directions.

4. The rotational component of claim 2, wherein the second portion is larger than the first portion.

5. The rotational component of claim 2, wherein the second portion extends an axial distance that is greater than half of the second axial distance that the resolver is configured to extend from the shelf portion.

6. The rotational component of claim 1, wherein the recess partially defines a neck and a head of the collar portion.

7. The rotational component of claim 6, wherein the neck is configured to be deformed to allow the head to contact the resolver in a process of staking.

8. A rotational component for a rotary system, comprising:
a sleeve that defines an aperture extending therethrough, through which an axis about which the rotational component is configured to rotate in the rotary system extends, the sleeve comprising:
a shelf portion configured to accommodate a resolver of the rotary system that rests upon the shelf portion; and
a collar portion that extends axially from the shelf portion to a distal end of the collar portion, the collar portion having an interior surface that partially defines the aperture and an exterior surface opposite the interior surface, wherein the exterior surface includes a defining face that defines a recess, wherein the defining face includes a first portion that initiates at a first axial distance from the shelf portion and extends to a second portion that angles radially outboard as the second portion extends axially toward the shelf portion therefrom.

9. The rotational component of claim 8, wherein the first axial distance is greater than a second axial distance that the resolver is configured to extend from the shelf portion.

10. The rotational component of claim 8, wherein the first portion of the defining face follows a curve within a plane defined by an axial direction and a radial direction.

11. The rotational component of claim 10, wherein the second portion extends substantially linearly within the plane.

12. The rotational component of claim 11, wherein the second portion is larger than the first portion.

13. The rotational component of claim 8, wherein the rotational component is a portion of a rotor hub.

14. The rotational component of claim 8, wherein the rotational component is a rotor flange of the rotor hub.

15. A method of assembling a resolver to a rotational component configured to rotate about an axis, comprising the steps of:
disposing a resolver about a collar portion of a sleeve of the rotational component, such that the resolver contacts a shelf portion of the sleeve that extends radially outboard relative to the collar portion, wherein an exterior surface of the collar portion includes a defining face that defines a recess that initiates at a first axial distance from the shelf portion and extends toward the shelf portion therefrom, and wherein the resolver is disposed such that the resolver extends a second axial distance from the shelf portion that is less than the first axial distance; and
deforming the sleeve, such that a portion of the defining face of the collar portion wraps about a corner of the resolver, sandwiching the resolver against the shelf portion to limit axial deformation of the resolver.

16. The method of claim 15, wherein the step of deforming the sleeve comprises staking a portion of the sleeve.

17. The method of claim 16, wherein, in the step of deforming the sleeve, a plurality of portions of the sleeve that are circumferentially offset from each other are deformed via staking.

18. The method of claim 15, wherein, prior to the step of deforming the sleeve, the defining face includes a first portion that initiates at the first axial distance from the shelf portion and extends to a second portion that angles radially outboard as the second portion extends axially toward the shelf portion therefrom.

19. The method of claim 18, wherein, prior to the step of deforming the sleeve, the first portion of the defining face follows a curve within a plane defined by an axial direction and a radial direction.

20. The method of claim 19, wherein, prior to the step of deforming the sleeve, the second portion extends substantially linearly within the plane.
